(19) United States
(12) Patent Application Publication
(10) Pub. No.: US 2020/0169280 A1
(43) Pub. Date: May 28, 2020

(54) OPEN CORNER BRACKETS FOR CELL PHONE STORAGE

(71) Applicant: Brian C. Montgomery, Wildwood, MO (US)

(72) Inventor: Brian C. Montgomery, Wildwood, MO (US)

(21) Appl. No.: 16/198,901

(22) Filed: Nov. 23, 2018

(51) Int. Cl. H04B 1/3827; H04M 1/02

(52) U.S. Cl. CPC H04B 1/385; H04M 1/0202

(57) ABSTRACT

The invention relates generally to a compression shirt or compression sleeve or jacket sleeve with a carry system for cell phones, and more particularly to wallets useful for organizing, carrying, and displaying essential items. The brackets and arm bands are so designed that the user can use the device visual display and data entry area while the device is attached to the user's arm.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The invention relates generally to a compression shirt or compression sleeve or jacket sleeve with a carry system for cell phones with a cell phone case or not. More specifically phones that are between 3.5 inches wide and 6.5 inches long.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Electronic devices such as portable music players, cell phones, and personal digital assistants (PDAs) are used every day by millions of people. Though electronic devices are becoming smaller, carrying these electronic devices may still present a problem. For example, PDAs and hybrid PDA-cell phone devices are typically large and cumbersome to place in a pocket. Similarly, carrying and using a portable music player while exercising can be a challenge.

Existing techniques for carrying these electronic devices involve using: belt clips, necklace cases, and armbands. Belt clips are typically used for larger devices such as PDAs and hybrid PDA-cell phone devices. However, these belt clips can be bulky and cumbersome to use. Necklace cases can be used for smaller electronic devices such as portable music player, but are not practical for larger electronic devices. Armbands are typically used to carry portable music players while exercising. However, existing armbands have a number of disadvantages. More specifically, existing armbands are relatively large, do not let skin breathe through the armband, do not stretch, and become brittle as the armband ages.

U.S. Pat. No. 7,251,197 to Yoshida et al. discloses an arm mounted wrist-watch sized communication device with a ear piece and microphone. U.S. Pat. No. D541,179 to Ahlstrom discloses an arm mounted wrist-watch sized device that serves as a wrist watch, a wrist computer and a diving computer. U.S. Pat. No. 7,234,010 to Gilmour discloses a wrist-watch sized data storage device.

These devices are based on the assumption that cell phones, other communication devices and computers will evolve downward in size until they are the size of conventional wrist watches. This assumption may not hold true for many communication devices. The inventors research on computer screens demonstrated that increasing the size of a computer screen increases user productivity. Many users may decide that increased display size in more important than ultra-small communication devices.

Other inventors have disclosed apparatus that hold cell phone sized devices. U.S. Pat. Nos. D493,280 and D503,038 to Tabata disclose apparatus designed to hold a cell phone on a users wrist. U.S. Pat. No. D536,867 to Sexson discloses a bracket apparatus for holding a cell phone to a users wrist. U.S. Pat. No. D527,893 to Martz discloses an apparatus to holding a cell phone to a users leg.

None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

In order to solve the above problems, the proposed invention comprised of a method and apparatus for protecting a cell phone from damage by securing it to the person wearing the arm sleeve, jacket other article of clothing while still providing access to all functionality. The invention has a specially designed patch bracket guide. The patch bracket guide allows the sleeve to activate the stretch properties of the elastic with any phone bigger than 2.5 inches×4 inches and up to 3.5×7 inches. The patch bracket guide allows the stretch against itself design to move vertically and horizontally through the patch.

The invention has a pocket for key, credit card and money storage. The invention employs an elastic type system that connects the four corner brackets in which each corner of the phone sits in. The elastic weaves through the corner brackets and through the patch system. Then that system is attached to a neoprene fabric under the brackets and that is sewn into the arm sleeve to prevent sweat from getting to the phone. The space stretches based off of the size of the phone and the brackets have a 0.5 inch space that fits most cell phones or other cell phone size devices. The whole thing is held in place based off of the close proximity of the neoprene to the tight compression or the article of clothing.

Another preferred embodiment is to overcome the shortcomings and disadvantages found in prior art by providing a universal system to store and use a cell phone Android or IOS or other without a person holding it in their hands. Also this shirt, jacket, arm sleeve or other article of clothing wears and fits like any other compression shirt or arm sleeve or other article of clothing. It allows a cell phone user to take self-facing pictures and fully access their device.

Due to the open nature of the brackets No matter the make or model of the phone there will be a place to plug in headphones. Also the close proximity of the phone allows easy Bluetooth use. The clothing and or arm sleeve is washable buy putting in in a bra like washable bag then allowed to air dry. The actual bracket is made of a plastic, rubber or metal material. It was designed to allow access to all buttons used on the phone and the middle space fits most of today's phones.

Another object of the present invention is that this allows the user to mount the device directly to his/her arm. The brackets and arm bands are so designed that the user can use the device display segment and data entry segment while the device is attached to the user's arm.

It is also the object of this invention to specifically, In case of phone as the handheld device, once the phone is in use the speaker can be used and conversation can continues while the hands are completely free.

It is yet another object of this invention is to provide dialing or pushing any relevant buttons to use the device and operate it as desired without holding the device in hand thus rendering hands free.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an illustration of the patch bracket guide attached to a piece of 4 way stretch neoprene. Four identical brackets are needed to create the Arm Gauntlet.

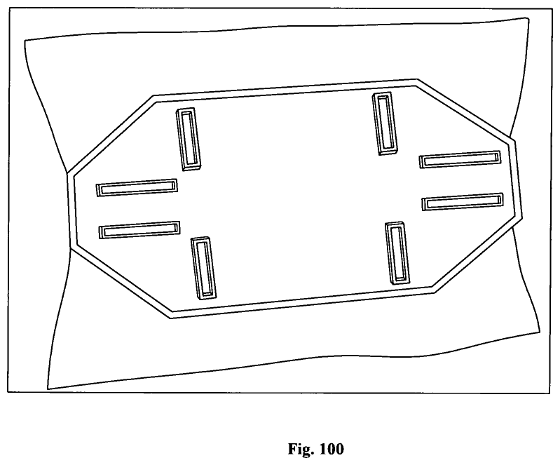

FIG. 2 is an illustration of a phone in the brackets and it shows how the brackets still give full frontal access to the cell phone.

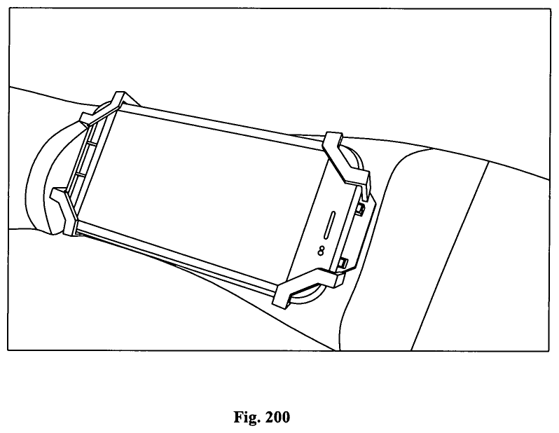

FIG. 3 is an illustration that shows an arm sleeve complete with the brackets attached and a generic phone in the arm gauntlet.

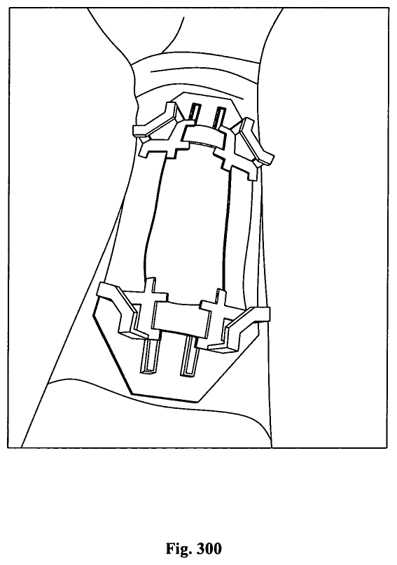

FIG. 4 is a plain view of the invention.

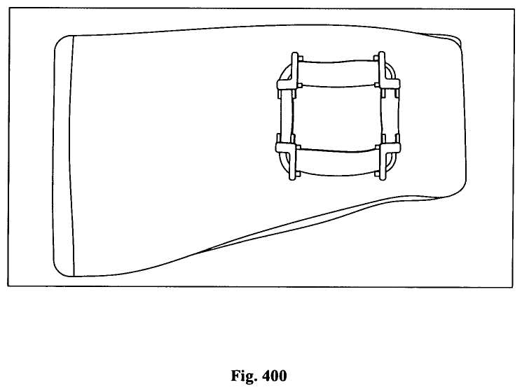

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The preferred embodiment of the current invention is a pocket for key, credit card and money storage. The invention employs an elastic type system that connects the four corner brackets in which each corner of the phone sits in. The elastic weaves through the corner brackets and through the patch system. Then that system is attached to a neoprene fabric under the brackets and that is sewn into the arm sleeve to prevent sweat from getting to the phone. The space stretches based off of the size of the phone and the brackets have a 0.5 inch space that fits most cell phones or other cell phone size devices. The whole thing is held in place based off of the close proximity of the neoprene to the tight compression or the article of clothing.

The device has a low profile and ergonomically thin to accommodate various handheld devices without being bulky or cumbersome for operation. This device facilitate rotation, sliding qualities that eliminates any unwanted hand twisting to observe the screen and make it much easier to operate the handheld device with no struggle and minimal effort.

Another preferred embodiment is the method of production that is novel In addition, it make the operator hand truly free of any engagement while involved in other task or action or operation such as driving, running, walking, cooking, and other related activities.

The invention has a pocket for Essential documents which a user cannot afford to lose. Essential documents include but are not limited to identification papers such as passports, driver's licenses, birth certificates, identification cards, and copies thereof; and travel documents such as airline tickets, bus tickets, train tickets, maps, itineraries, boarding passes, medical information cards, insurance documentation, and copies thereof.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A stretchable cell phone case used in conjunction with a user's article of clothing to secure a cell phone, said cell phone case characterized by:
a patch bracket guide having four corner brackets wherein each corner of said cell phone is configured to sit in;
an elastic made to weave through each of said corner brackets and the patch of said patch bracket guide; and
said patch bracket guide fixed onto said article of clothing to prevent sweat from entering into said cell phone, wherein said elastic connects said four corner brackets and allows said four corner brackets to move in horizontal and vertical directions within said patch bracket guide, thereby securing said cell phone inside said cell phone case.

2. The stretchable cell phone case as claimed in claim 1, wherein said patch bracket guide fixed onto said article of clothing facilitates the mounting of said cell phone to said user's wrist.

3. The stretchable cell phone case as claimed in claim 1 configured to comprise a pocket for keeping one or more essential items including but not limited to a passport, a driver's license, a birth certificate, an airlines ticket, a bus ticket, a train ticket, an itinerary, a map, a boarding pass, a medical information card, an insurance policy document and any combinations thereof.
